(19) United States
(12) Patent Application Publication
(10) Pub. No.: US 2021/0373356 A1
(43) Pub. Date: Dec. 2, 2021

(54) Modular Eyeglasses

(71) Applicant: Dartangnan Walker, Inglewood, CA (US)

(72) Inventor: Dartangnan Walker, Inglewood, CA (US)

(21) Appl. No.: 17/335,971

(22) Filed: Jun. 1, 2021

Related U.S. Application Data
(60) Provisional application No. 63/032,494, filed on May 29, 2020.

(51) Int. Cl. G02C 5/22; G02C 5/14

(52) U.S. Cl. CPC G02C 5/22; G02C 2200/06; G02C 2200/08; G02C 5/143

(57) ABSTRACT

A modular eyewear system and apparatus is described. The apparatus includes eyepieces equipped with exchangeable arms which are configured to easily detach from a primary frame of the eyewear via quick-release clasps. Arms of the eyewear may be exchanged at will in order to accommodate differing styles, colors, patterns, materials, and textures in accordance with the style and immediate desire of the wearer. The quick-release mechanism includes an interlocking hook system which is manipulated via a lever by the user. Upon unlocking the mechanism, the arm of the frame may be removed easily and exchanged with one of a variety of compatible arms.

### CONTINUITY

This application is a non-provisional application of provisional patent application No. 63/032,494, filed on May 29, 2020, and priority is claimed thereto.

### FIELD OF THE PRESENT INVENTION

The present invention relates to the field of eyewear, and more specifically relates to a modular eyeglasses framework configured to facilitate the rapid customization of eyeglasses components via the quick and easy exchange of eyeglass components via an arm-based quick-release mechanism.

### BACKGROUND OF THE PRESENT INVENTION

Eyewear is known to be a prominent fashion accessory for many individuals the world over. Sunglasses provide the critical function of protecting the wearer from glare from the sun, as well as eye damage. Similarly, prescription corrective lenses ensure that the wearer can see clearly. However, the frames for eyewear are rather expensive, which is notable for both prescription lenses as well as non-prescription lenses. This is especially true for quality eyewear that include anti-glare coatings, polarization, and scratch-prevention coatings which quickly increase the price of the eyewear.

As such, a majority of individuals only have one or two pairs of glasses. For example, an individual may one expensive pair of sunglasses and one cheaper pair to at least provide some selection of styling choice. In the case of prescription glasses, a majority of users only own a single pair due to the cost of frames and lenses combined. Many individuals wish to possess more style varieties at their disposal, but the cost to purchase and maintain a wide variety of eyewear in an assortment of colors, textures, and styles is cost prohibitive. If there were a way in which a single set of lens frames could be altered at-will by the user to augment the style of the eyewear, individuals could possess more choices in their desired style and color of eyewear.

Thus, there is a need for a modular eyewear system configured to facilitate the rapid exchange of stylistic components of the eyewear, including, but not limited to the arms, bridge, lenses, and other components. Such a system is preferably configured to enable the user to easily exchange the arms of the eyewear via a quick-release hook mechanism at-will to enable the alteration of the overall style of the eyewear when desired.

### SUMMARY OF THE PRESENT INVENTION

The present invention is a modular eyewear apparatus and system configured to enable the on-the-go exchange of components of the apparatus to facilitate a rapid change of appearance and style of the eyewear at the discretion of the user. The preferred embodiment of the present invention is equipped with a quick-release hook mechanism disposed within sockets of the frame which enable the connection and subsequent disconnection of compatible arms to the frame. As such, the arms are equipped with a mirrored opposite hook configured to connect to the hook of the socket of the frame to ensure a firm and solid connection of the arms to the frame. The hook of each arm is preferably manipulated via a lever disposed in pivotal connection with the hook of each arm. Arms are preferably available in a variety of assorted colors, textures, patterns, shapes, and sizes in accordance with the needs and wishes of the end user.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a view of the apparatus of the present invention as seen from the side.

FIG. 2 exhibits a view of the apparatus of the present invention as seen from the front.

FIG. 3 shows a flow chart detailing the process of use of the present invention by a user.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is a modular eyewear system and apparatus configured to enable the rapid and easy exchange of components of the apparatus at the will of the user in accordance with the style desired by the user at any given time.

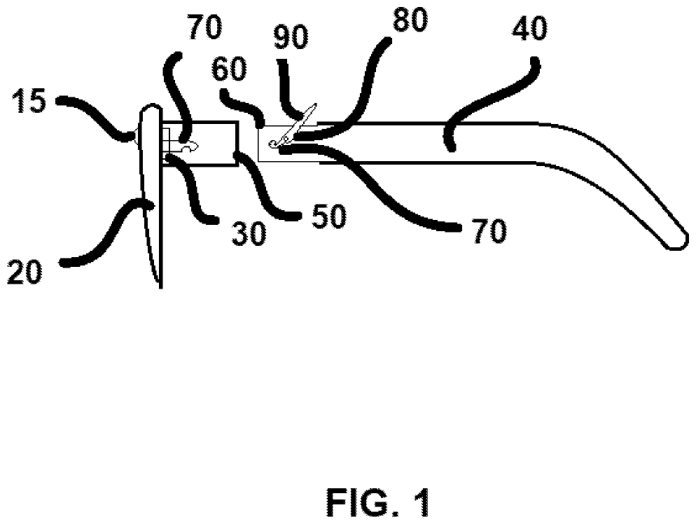

The preferred embodiment of the present invention includes a frame (10) containing lenses (20). Alternately, the frame (10) may be connected to the lenses (20) via screws (15). The frame (10) preferably includes the bridge. Adjacent to the lenses (20), hinges (30) are present which facilitate the conventional folding of arms (40) which are held in position via sockets (50) disposed behind the hinges (30) in line with the arms (40) themselves as shown in FIG. 1.

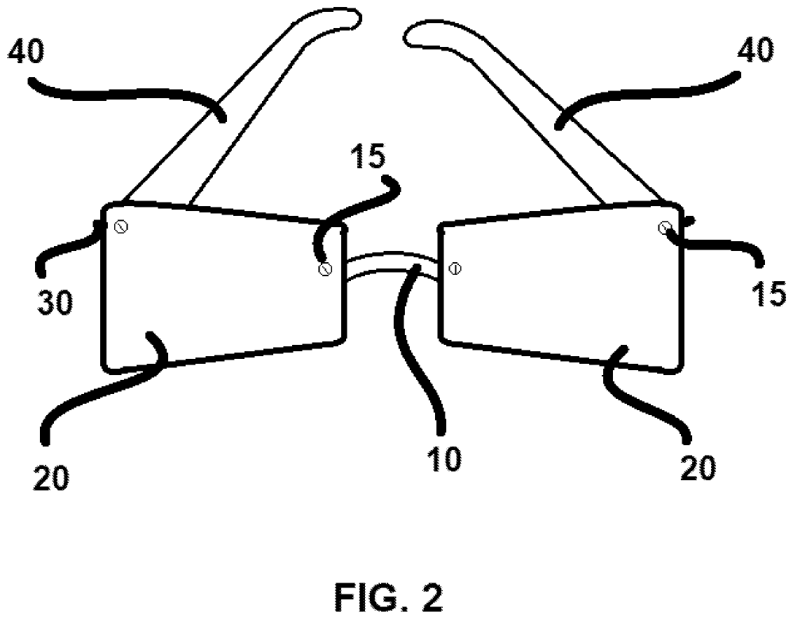

The sockets (50) of the frame (10) are configured to accept a male portion (60) of arms (40) of the apparatus. Both the sockets (50) as well as the male portions (60) are equipped with hooks (70). The hook (70) of the male portion (60) of each arm (40) is configured to pivot about a pivot point (80). The hook (70) of the arm (40) is a mirrored and opposite image of the hook (70) of the socket (50). As such, the hook (70) of the arm (40) is configured to securely interlock with the hook (70) of the socket (50) upon connection of the male portion (60) of the arm (40) to the socket (50) of the frame (10). A lever (90) is present in communication with the pivot point (80) and hook (70) of each arm (40) of the system and apparatus of the present invention as shown in FIG. 2. The lever (90) facilitates the connection and disconnection of the arms (40) to the frame (10) via the socket (50) and male portion (60) of each iteration of modular arms of the present invention.

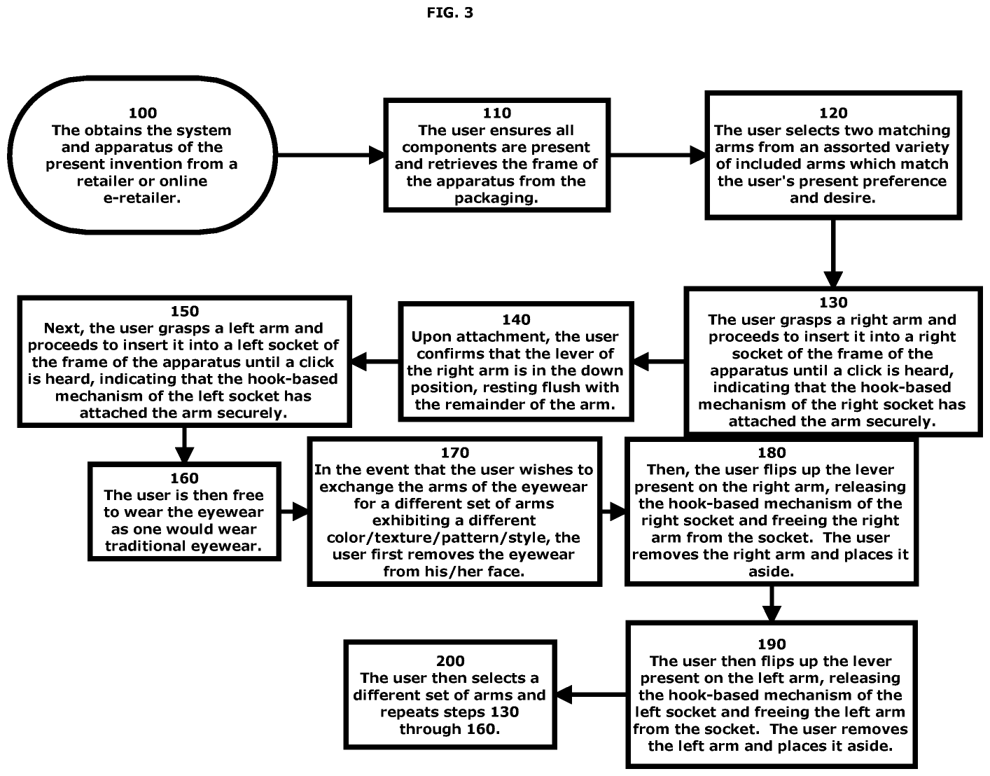

The process of installation and use of the system and apparatus of the present invention, as shown in FIG. 3, is preferably as follows:
1. The obtains the system and apparatus of the present invention from a retailer or online e-retailer. (100)
2. The user ensures all components are present and retrieves the frame of the apparatus from the packaging. (110)
3. The user selects two matching arms from an assorted variety of included arms which match the user's present preference and desire. (120)
4. The user grasps a right arm and proceeds to insert it into a right socket of the frame of the apparatus until a click is heard, indicating that the hook-based mechanism of the right socket has attached the arm securely. (130)
5. Upon attachment, the user confirms that the lever of the right arm is in the down position, resting flush with the remainder of the arm. (140)
6. Next, the user grasps a left arm and proceeds to insert it into a left socket of the frame of the apparatus until a click is heard, indicating that the hook-based mechanism of the left socket has attached the arm securely. (150)
7. The user is then free to wear the eyewear as one would wear traditional eyewear. (160)
8. In the event that the user wishes to exchange the arms of the eyewear for a different set of arms exhibiting a different color/texture/pattern/style, the user first removes the eyewear from his/her face. (170)
9. Then, the user flips up the lever present on the right arm, releasing the hook-based mechanism of the right socket and freeing the right arm from the socket. The user removes the right arm and places it aside. (180)
10. The user then flips up the lever present on the left arm, releasing the hook-based mechanism of the left socket and freeing the left arm from the socket. The user removes the left arm and places it aside. (190)
11. The user then selects a different set of arms and repeats steps 4 through 7. (200)

In some embodiments of the present invention, a carrying case is included which facilitates display and access to the wide variety of interchangeable components available to the system and apparatus of the present invention.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A modular eyewear system comprising:
a frame, said frame equipped with lenses, a first socket, and a second socket;
wherein said first socket and said second socket are perpendicular to said lenses;
hinges, said hinges present at a first end and a second end of said frame;
wherein said first socket and said second socket are disposed in communication with said frame via said hinges;
socket hooks, said socket hooks present within said first socket and said second socket;
an assortment of paired arms, each arm of said assortment of paired arms having a matching arm disposed in an opposing orientation to form a right arm and a left arm of the eyewear;
arm hooks, said arm hooks present on a first end of said paired arms;
ear contours, said ear contours present on a second end of said paired arms;
wherein said arm hooks of said paired arms are configured to interlock with said socket hooks of said first socket and said second socket when said paired arms are inserted into said first socket and said second socket;
a first lever, said first lever disposed on said first socket;
a second lever, said second lever disposed on said second socket;
wherein said first lever is configured to release said arm hook of said arm from said socket hook of said first socket when manipulated; and
wherein said second lever is configured to release said arm hook of said arm from said socket hook of said second socket when manipulated.
